(19) United States
(12) Patent Application Publication
(10) Pub. No.: US 2012/0015837 A1
(43) Pub. Date: Jan. 19, 2012

(54) METHOD FOR DIAGNOSING ENDOMETRIAL CANCER

(75) Inventors: Mikio MIKAMI, Tokyo (JP); Akihiro UMEZAWA, Tokyo (JP)

(73) Assignee: TOKAI UNIVERSITY EDUCATIONAL SYSTEM, Tokyo (JP)

(21) Appl. No.: 13/014,946

(22) Filed: Jan. 27, 2011

(30) Foreign Application Priority Data
Jul. 13, 2010 (JP) 2010-158575

(51) Int. Cl. C40B 30/04

(52) U.S. Cl. 506/9

(57) ABSTRACT

An object of the present invention is to provide a method for diagnosing endometrial cancer by comprehensively analyzing the glycan structures of glycoprotein with the normal endometrium and endometrial cancers (well-differentiated/poorly-differentiated), using the lectin microarray system. The present invention provides a method for diagnosing or determining the state of normal endometrium or endometrial cancer/cancer stages by glycan profiling using a structure of a glycoprotein in a sample as an indicator.

### FIELD OF THE INVENTION

The present invention relates to a method for diagnosing endometrial cancer. More particularly, the present invention relates to a method for diagnosing endometrial cancer by glycan profiling using lectin microarray analysis, which is an emerging technology that enables ultrasensitive detection of multiplex lectin-glycan interactions.

### BACKGROUND ART

Glycosylation is a critical post- or co-translational modification found in more than 50% of eukayotic proteins. Thus, the glycome, which represents the total set of glycans expressed in a cell, is believed to be information-rich, as it varies among cell types, stages of development and differentiation, and even in the malignant transformation processes. Lectins have long been used as tools to characterize cell surface glycans, such as for blood-group typing, tissue staining, lectin-probed blotting and flow cytometry. The use of lectins in glycan profiling provides considerable advantages. A modern technology to discriminate glycan profiling is lectin microarray analysis, which is an emerging technology that enables ultrasensitive detection of multiplex lectin-glycan interactions is based on a unique principle, that is, the evanescent-field fluorescence-detection principle, which has been used extensively for biosensors to study real-time binding events on the glass slide surfaces. Thus, the evanescent-field methods have greater advantage to analyze relatively weak interactions between lectins and glycoproteins in a liquid phase at equilibrium. Furthermore, this method is applicable for the analysis of the physiological and pathological status of crude glycoproteins extracted from mammalian cells and cell surfaces. This method is based on the concept of glycan profiling, and utilizes lectins, a group of glycan-discriminating proteins. Changes in glycosylation patterns correlate well with alterations in the gene expression of individual glycosyltransferases in carcinogenesis and oncogenesis, as well as in cell differentiation and proliferation. Therefore, it is quite possible, by means of differential profiling, to identify aberrant cell surface glycans. Owing to its extremely high sensitivity and accuracy, the lectin microarray system is the best tool for a ‘cell profiler’, and it is expected to be applicable for selection of cancer-specific lectins and for quality control of stem cells before transplantation.

### CITATION LIST

Kuno A et al (2005) Evanescent-field fluorescence-assisted lectin microarray: a new strategy for glycan profiling. Nat Methods 2:851-856.

### SUMMARY OF THE INVENTION

A glycoprotein sugar chain or a glycolipid sugar chain that covers a cell membrane is involved in functions such as mutual recognition and differentiation of cells and is a substance attracting attention in reproductive medicine and oncology. The present inventors have analyzed glycan profiling in endometrial cancer and examined the stage specific glycan structures in well-differentiated endometrial cancer and differentiation of the cancer. In accordance with the present invention, a problem to be solved is to provide a method for diagnosing endometrial cancer by comprehensively analyzing the glycan profiling for the normal endometrium and endometrial cancers (well-differentiated/poorly-differentiated), searching the glycan structures expressed characteristically in each.

The present inventors have conducted detailed studies to solve the above-mentioned problem, and have used normal endometrium and endometrial cancer tissues collected from extirpated specimens as materials, and have labeled membrane proteins extracted from the tissues with fluorescence. The present inventors have performed glycan profiling by using lectin microarrays system, and have compared the normal endometrium to the endometrial cancers (well-differentiated/poorly-differentiated). As a result, these glycan profilongs has been found that a difference between the normal endometrium and the endometrial cancers was observed for the expression of the glycoproteins recognized with UEA-1, SSA, SNA, BPL and ACA lectins. The present invention has been achieved based on these findings.

Thus, the present invention provides the following subject matter.

(1) A method for diagnosing or determining endometrial cancer by glycan profiling.
(2) The method according to (1), wherein the glycan profiling in the sample, is analyzed by lectin microarray system.
(3) The method according to (2), is based on a unique principle, that is, the evanescent-field fluorescence-detection principle, which has been used extensively for biosensors to study real-time binding events on the glass slide surfaces. The evanescent-field methods have greater advantage to analyze relatively weak interactions between lectins and glycoproteins in a liquid phase at equilibrium.
(4) The method according to (1), wherein glycan profiling by signal pattern of 45 lectins on glass slide is that lectin signal of UEA-1, BPL and ACA with endometrial cancer is higher than normal endometrium. That is, signal pattern of three lectins on lectin signal of a sample using lectin microarray evaluate a diagnosis or a determination whether endometrial cancer or normal.
(5) The method according to (1), wherein glycan profiling by signal pattern of 45 lectins on glass slide is that lectin signal pattern of UEA-1 and ACA with endometrial cancer evaluate a diagnosis or a determination whether endometrial cancer type G1 (well-differentiated) or type G3 (poorly-differentiated). That is, UEA-1 signal with G1 is lower than that with G3, while ACA signal with G1 is higher than that G3.
(6) The method according to (1), wherein stage I endometrial cancer type G3 and stage III or IV endometrial cancer type G3 are determined depending on lectin signal pattern with one or more lectins selected from DBA, ACA, VVA, LTL, SBA, BPL, HPA, ECA and AOL lectins.

In accordance with the present invention, it has been found that glycan profiling on a cell membrane surface is changed by the cancerization of the endometrium and the differentiation of the cancer. The characteristics of the cancer (malignancy, sensitivity to an anticancer agent, sensitivity to radiation, metastaticity, and invasive capacity) can be diagnosed by examining the profile of the cell membrane surface sugar chain of the endometrial cancer by the lectin array. The present invention can be applied to early diagnosis of uterine cancer and selection of the therapeutic method by utilizing a technology for analyzing a sugar chain structure.

### BRIEF DESCRIPTION OF THE DRAWINGS

FIG. 1 illustrates the results of hierarchical clustering analysis and principal component analysis of 6 lectins (TJA-I, SSA, SNA, BPL, ACA, UEA-1) based on lectin profiling using the lectin microarray with normal endometrium, the well-differentiated endometrial cancer tissues and the poorly-differentiated endometrial cancer tissues. Each is reproducibly sub-categorized into groups of tissue types.

FIG. 2 illustrates the results of hierarchical clustering analysis and principal component analysis of lectin profiling using the lectin microarray with the well-differentiated endometrial cancer type (G1) and the poorly-differentiated endometrial cancer type (G3)

FIG. 3 illustrates the results of hierarchical clustering analysis and principal component analysis of lectin profiling using the lectin microarray with samples of different stages on the G3 type endometrial cancer

### DESCRIPTION OF THE EMBODIMENTS OF THE INVENTION

Embodiments of the present invention will be explained in detail below.

In the method for diagnosing or determining endometrial cancer in accordance with the present invention, endometrial cancer is diagnosed or determined by using glycan profiling of a sample as an indicator.

As such samples, biological samples collected from a human or an animal (e.g., uterine body tissue, blood, urine, etc.), or primary culture cells or cell strains established from the biological samples can be used.

In the present invention, endometrial cancer is diagnosed or determined by using the glycan profiling as the indicator, and, preferably, the glycan structures of the glycoprotein can be analyzed based on binding with a lectin. A highly sensitive glycan profiler lectin microarray system on the basis of an evanescent-field fluorescence detection scanner. The fluorescence-labeled glycoproteins binding to the lectins immobilized on the glass slide were selectively detected with the aid of an evanescent wave (the area within 200 nm from the glass surface). The experimental process of the glycan profiling consists of four steps, as follows: step 1, sample preparation; step 2, binding reaction; step 3, array scanning; and step 4, data processing and analysis.

In the present invention, an analysis can be performed by spotting the fluorescent-labeled glycoprotein on the lectin array in which the lectins are immobilized on the carrier. The type of a fluorescent label is not limited in particular, but labels such as, for example, Cy3, Cy5, FITC, and rhodamine can be used. An analysis can also be performed by using an enzyme label such as, for example, horseradish peroxidase or alkaline phosphatase, instead of the fluorescent labels, and further using a suitable chromogenic substrate.

As a carrier on which the lectins are immobilized, an ELISA plate, a microarray, a column for chromatography, or the like can be used. Among the above, the ELISA plate or the microarray is preferred in that a lot of samples can simply and rapidly be detected. The lectin can be immobilized on the carrier according to a usual method. A biotinylated lectin may be added onto, for example, an ELISA plate and be left to stand overnight, so that the lectin is immobilized, followed by washing wells with PBS, adding BSA/PBS, and performing blocking at room temperature. Meanwhile, to confirm whether the lectin is bound to the carrier for immobilization, the lectin may previously be labeled with biotin or the like.

In the present invention, for example, a lectin-immobilized carrier on which lectins such as UEA-1, SSA, SNA, BPL and ACA are immobilized is brought into contact with a glycoprotein in a sample. Specifically, the glycoprotein labeled with a fluorescent or the like is added to the lectin-immobilized carrier, and the reaction is performed. After the reaction, fluorescence intensity can be measured by a suitable fluorescence detection apparatus.

In the present invention, for example, 1) glycan profiling by signal pattern of 45 lectins on glass slide is that lectin signal of UEA-1, BPL and ACA with endometrial cancer is higher than normal endometrium. That is, signal pattern of three lectins on lectin signal of a sample using lectin microarray evaluate a diagnosis or a determination whether endometrial cancer or normal; 2) Glycan profiling by signal pattern of 45 lectins on glass slide is that lectin signal pattern of UEA-1 and ACA with endometrial cancer evaluate a diagnosis or a determination whether endometrial cancer type G1 (well-differentiated) or type G3 (poorly-differentiated). That is, UEA-1 signal with G1 is lower than that with G3, while ACA signal with G1 is higher than that G3; 3) Stage I endometrial cancer type G3 and stage III or IV endometrial cancer type G3 are determined depending on lectin signal pattern with one or more lectins selected from DBA, ACA, VVA, LTL, SBA, BPL, HPA, ECA and AOL lectins.

The present invention will be explained in more detail with reference to Example as described below, but the present invention is not limited to the Example.

### Example

### (1) Materials and Methods

As materials, endometrium and endometrial cancer tissues collected from extirpated specimens were used (approved by the Ethical Review Board, with written consent obtained from patients). When the specimen was taken in the operating room, the site of the cancer was excised and put in an 1.5 ml tube, and it was stored at −80° C. When the specimen was processed, it was thawed, and the tissue was finely cut. Tissues (normal endometrium, well-differentiated endometrial cancer, and poorly-differentiated endometrial cancer) were washed with PBS and cut to a pieces (about 3 mm×3 mm). The membrane fractions were extracted from the tissue pellets using a CelLytic MEM Protein Extraction kit (Sigma, St. Louis, Mo.). Lectin microarray analysis was performed as previously described. Briefly, a small aliquot of protein fraction (200 ng) was labeled with Cy3-succimidyl ester (designated as Cy3-labeled glycoprotein). The lectin chip with LecChip™ with 45 lectins (GP BioSciences, Kanagawa, Japan) was incubated with the Cy3-labeled glycoprotein solution (100 μl) at a concentration of 0.25 and 0.5 μg/ml in probing buffer (TBS containing 0.05% Triton X-100) at 4° C. until binding reached equilibrium. Lectins are well known as glycan recognizers and are classified into several categories, for instance; fucose, sialic acid, asialo-form, agalacto-form, high mannose, O-glycan and branching structure recognizers. We calculated the net intensity value for each spot by subtracting a background value from signal intensity and then averaged the signal net intensity values of three spots. Lectin microarray data on each cell type was processed by the microarray system using a max-normalization procedure after a gain-merging process. The numerically converted data were statistically analyzed in NIA Array Analysis.

### (2) Results and Discussion

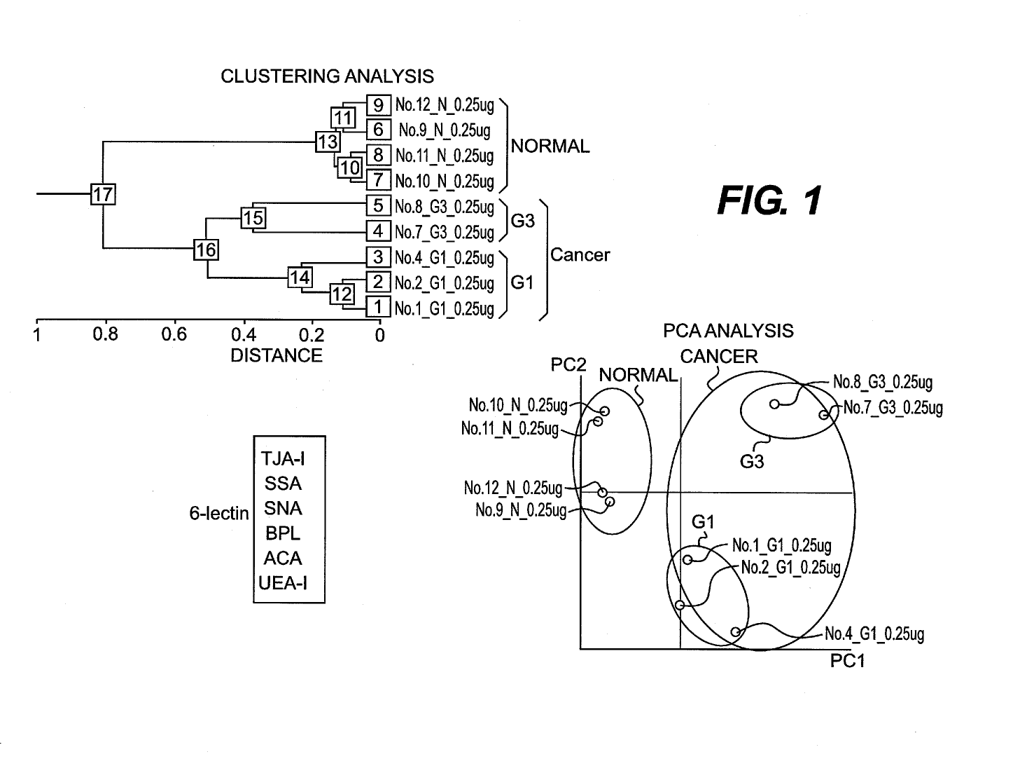

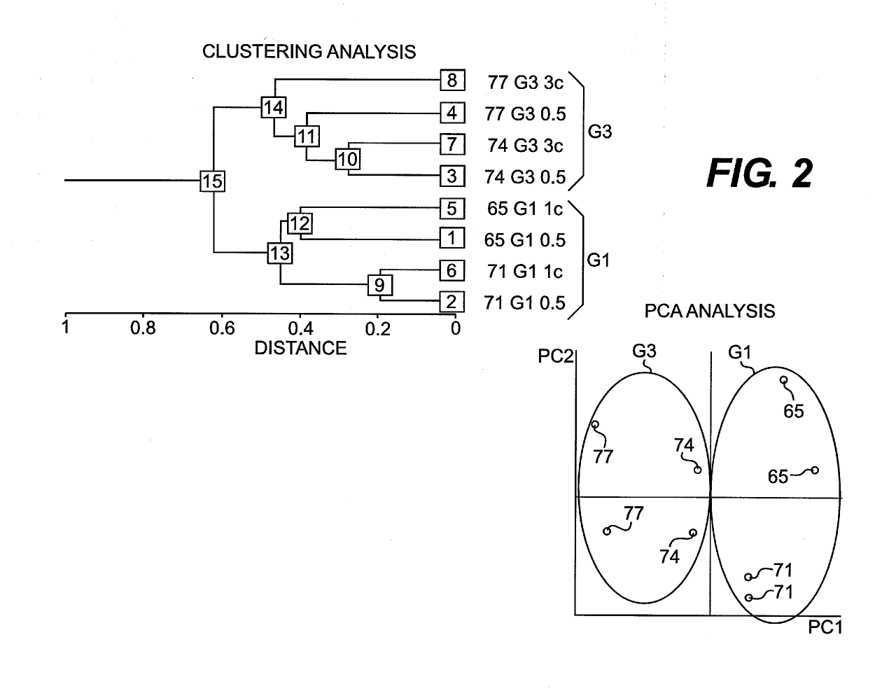

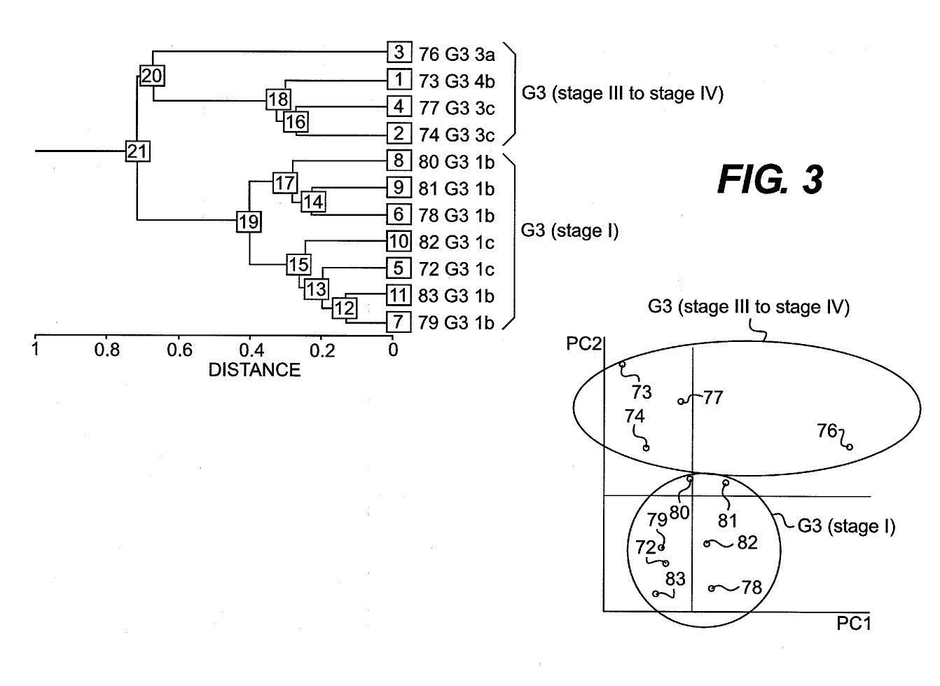

To clarify relationship with glycan profiling between the normal endometrium tissues and endometrial tissues, we performed lectin microarray analysis. Among 45 lectins, the six lectins such as TJA-I, UEA-1, SSA, SNA, BPL and ACA lectins were statistically observed the different signal based on lectin microarray between normal endometrium, endometrial cancer type G1 (the well-differentiated endometrial cancer tissues) and G3 (the poorly-differentiated type). Hierarchical clustering analysis on six lectins (TJA-I, SSA, SNA, BPL, ACA, UEA-I) revealed that normal endometriums were reproducibly categorized into an independent group. And also in cancer tissues, G1 and G3 were significantly categorized into distinct groups (FIG. 1). Principal component analysis (PCA) revealed UEA-I, ACA and BPL were the lectins that were distinct between normal and cancer; ACA and UEA-I were the lectins that were distinct between G1 and G3 (FIG. 1). The use of these lectins allowed for distinguishing between the normal endometrium and the endometrial cancers (well-differentiated/poorly-differentiated) (FIG. 1). Experiments on reproducibility were tried. When statistical analyses on lectin microarray data of other cancer tissues of G1 and G3 were performed by using the 45 lectins. G1 type endometrial cancers were able to be distinguished from the G3 type endometrial cancers (FIG. 2). Next clinically diagnosis of cancer stage on endometrial cancer type G3 is very important because it is different to approach to therapy with a stage. So we performed the tissues of different stage on G3 type endometrial cancer were collected and analyzed by lectin microarray. By focusing attention on a progression stage, it was possible to be separated into stage I and advance stages III or higher. Further statistical processing leaded to the extraction of the lectins which show significant difference between the stage I and the stages III or higher. A significant difference lectin signal pattern between the stage I cancers and the stages III or more progressive cancers was observed for the glycoprotein expression recognized by DBA, ACA, VVA, LTL, SBA, BPL, HPA, ECA and AOL. The analyses of the nine lectins also allowed for the distinct separation (FIG. 3).

The results described above indicated that pathological diagnosis can be performed by glycan profiling based on lectin signal using the lectin microarray and, in addition, the biochemical characteristics of the cancer cells can be defined by the lectin microarray. In accordance with the present invention, it was found that the glycan structures of cell surface is changed by the cancerization of the endometrium and the differentiation of the cancer. The characteristics of the cancer (malignancy, sensitivity to an anticancer agent, sensitivity to radiation, metastaticity, and invasive capacity) can be estimated and diagnosed by examining the profile of the cell membrane surface sugar chains of various gynecologic cancers by the lectin microarray.

1. A method for diagnosing or determining endometrial cancer by glycan profiling based on lectin microarray in a sample as an indicator.

2. The method according to claim 1, wherein the glycan profiling in the sample, is analyzed by lectin microarray system.

3. The method according to claim 2, is based on a unique principle, that is, the evanescent-field fluorescence-detection principle, which has been used extensively for biosensors to study real-time binding events on the glass slide surfaces. The evanescent-field methods have greater advantage to analyze relatively weak interactions between lectins and glycoproteins in a liquid phase at equilibrium.

4. The method according to claim 1, wherein glycan profiling by signal pattern of 45 lectins on glass slide is that lectin signal of UEA-1, BPL and ACA with endometrial cancer is higher than normal endometrium. That is, signal pattern of three lectins on lectin signal of a sample using lectin microarray evaluate a diagnosis or a determination whether endometrial cancer or normal.

5. The method according to claim 1, wherein glycan profiling by signal pattern of 45 lectins on glass slide is that lectin signal pattern of UEA-1 and ACA with endometrial cancer evaluate a diagnosis or a determination whether endometrial cancer type G1 (well-differentiated) or type G3 (poorly-differentiated). That is, UEA-1 signal with G1 is lower than that with G3, while ACA signal with G1 is higher than that G3.

6. The method according to claim 1, The method according to (1), wherein stage I endometrial cancer type G3 and stage III or IV endometrial cancer type G3 are determined depending on lectin signal pattern with one or more lectins selected from DBA, ACA, VVA, LTL, SBA, BPL, HPA, ECA and AOL lectins.
